(19) United States
(12) Patent Application Publication
(10) Pub. No.: US 2013/0320929 A1
(43) Pub. Date: Dec. 5, 2013

(54) SELF-CONTAINED POWER SUPPLY

(71) Applicant: Walker Solar Products, LLC, Mansfield, GA (US)

(72) Inventors: Landis C. Walker, Mansfield, GA (US); Brent Webb, Marietta, GA (US); Garland Ashe, Blue Ridge, GA (US)

(21) Appl. No.: 13/907,114

(22) Filed: May 31, 2013

Related U.S. Application Data
(60) Provisional application No. 61/653,713, filed on May 31, 2012.

(51) Int. Cl. H02J 7/00

(52) U.S. Cl. CPC H02J 7/0022
USPC 320/128

(57) ABSTRACT

Disclosed are various embodiments for a self-contained power supply. A container is configured to be placed separate from a powered structure, such as a house or place of business. The container houses a power supply unit that includes a battery bank and an inverter. The battery bank receives multiple charging currents from multiple power sources, such as a grid power source and an auxiliary power source. The inverter uses electrical energy stored by the battery bank to provide an output current to the powered structure.

### CROSS-REFERENCE TO RELATED APPLICATIONS

This application claims priority to co-pending U.S. Provisional Application Ser. No. 61/653,713, filed May 31, 2012, which is hereby incorporated by reference herein in its entirety.

### BACKGROUND

Powered structures, such as homes or places of business, typically obtain electrical power from “the grid” that is maintained by an electric utility company. Recently, fuel-powered, solar-powered, and wind-powered generators have been used as auxiliary power sources. These auxiliary power sources may supplement or even replace power obtained from the grid.

Installation of an auxiliary power source typically involves hiring an electrician to perform the installation services. Nonetheless, installation of the auxiliary power source may be complicated and the electrician may be unfamiliar with the proper installation procedure. Thus, there currently exists a desire to facilitate the installation of an auxiliary power source for a powered structure.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIGS. 1-3 are drawings of a powered environment according to various embodiments of the present disclosure.

FIG. 4 is a drawing of a container in a powered environment of FIGS. 1-3 according to various embodiments.

FIG. 5 is a flowchart illustrating one example of functionality implemented in association with a power supply unit in a powered environment of FIGS. 1-3 according to various embodiments of the present disclosure.

FIG. 6 is a schematic block diagram that provides one example illustration of a controller device employed in a powered environment of FIGS. 1-3 according to various embodiments of the present disclosure.

### DETAILED DESCRIPTION

The present disclosure is directed towards a self-contained power supply that may facilitate providing battery power and/or an auxiliary power source to a powered structure. As a non-limiting example, a battery bank, an inverter, and possibly other components are enclosed within a container. The battery bank receives charging currents from any one or more of multiple power sources. For example, one of the power sources may be a grid power source, and another power source may be an auxiliary power source. The inverter obtains an electrical current from the battery bank and provides electrical power to the powered structure. The container is configured to be placed separate from a powered structure to which the power supply unit is configured to provide power.

Because various components of the system are enclosed within the container, connection of the power supply and/or auxiliary power source to the powered structure may be facilitated. In addition, the container may be portable thereby facilitating deployment and usage in emergency relief situations, for example. In the following discussion, a general description of the system and its components is provided, followed by a discussion of the operation of the same.

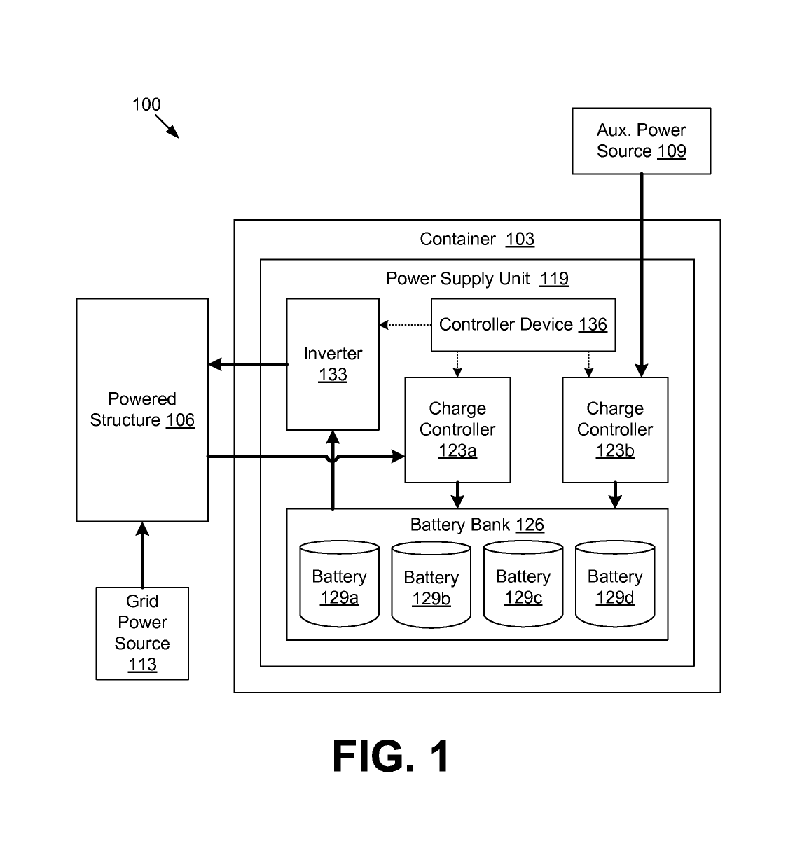

With reference to FIG. 1, shown is a powered environment 100 according to an embodiment, among many embodiments, of the present disclosure. The powered environment 100 includes a container 103, a powered structure 106, an auxiliary power source 109, a grid power source 113, and possibly other components.

The powered structure 106 may be, for example, a house, office, mobile home, boat, recreational vehicle, trailer, heating unit, air conditioning unit, or any other structure that is configured to receive electrical power. The powered structure 106 may be configured to receive power from a grid power source 113 or another source. The grid power source 113 may be an electrical power network maintained by one or more utility companies. Various components enclosed in the container 103 may be configured to electrically connect to the grid power source 113 via the powered structure 106. Additionally, the powered structure 106 may be configured to receive power provided by various components enclosed within the container 103.

The auxiliary power source 109 may be a power source that is in addition to the grid power source 113. As non-limiting examples, the auxiliary power source 109 may be provided by a photovoltaic array (i.e., solar powered generator), wind-powered generator, geothermal-powered generator, hydro-powered generator, fuel-powered generator, or any other type of device of like capability. The auxiliary power source 109 may provide a charging current to various components enclosed in the container 103. Depending on the type of the particular auxiliary power source 109, the charging current may be an alternating current or direct current.

The container 103 may be a housing configured to enclose various components of the container 103. To this end, the container 103 may be composed of, for example, steel, aluminum, brass, plastic, or any other material or combination of materials. Additionally, various components of the container 103 may be configured to electrically connect to components associated with the powered structure 106, auxiliary power source 109, and/or possibly other components.

The container 103 is configured to be placed separate from the powered structure 106. In this sense, the container 103 may be placed, for example, next to the powered structure 106 or at another location that is separate from the powered structure 106. In various embodiments, the container 103 may be mounted to a truck, trailer, pallet, sled, or any other transportation unit to facilitate transportation of the container 103. Being mounted to a transportation unit may further facilitate deployment of the container, for example, in response to an emergency situation such as after a natural disaster.

Various components may be enclosed within the container 103. For example, a power supply unit 119, and possibly other components may be enclosed within the container 103. The power supply unit 119 is configured to receive a plurality of charging currents, store electrical energy, and provide at least one output power. To this end, the power supply unit 119 may comprise one or more charge controllers 123a-123b, a battery bank 126, one or more inverters 133, one or more controller devices 136, and possibly other components not discussed in detail herein. For instance, the power supply unit 119 may include circuit breakers, fuses, ground connections, and/or other features not discussed in detail herein.

The charge controllers 123a-123b may be configured to receive charging currents from one or more power sources, such as the grid power source 113 and/or auxiliary power source 109, and provide the charging currents to the battery bank 126. The charge controllers 123a-123b may also monitor and control the charging currents so as to control various parameters associated with the battery bank 126. For example, the charge controllers 123a-123b may control the charging current so as to determine a charge rate or other parameter. Additionally, the charge controllers 123a-123b may include a rectifier or other hardware to facilitate converting alternating current into direct current, in the event that an alternating current is received.

The battery bank 126 may receive one or more charging currents and store electrical energy. To this end, the battery bank 126 may comprise one or more batteries 129a-129d. The batteries 129a-129d can be flooded (wet) lead acid batteries, absorbed glass mat (AGM) batteries, and/or other suitable batteries.

Additionally, in various embodiments the battery bank 126 may include a connector or other component to facilitate expanding the battery bank 126 by connecting additional batteries 129a-129d or additional battery banks 126.

Using the stored electrical energy, the battery bank 126 may provide an electrical current and voltage as an output. As non-limiting examples, the battery bank 126 may be designed to provide a 24 volt output, a 48 volt output, or other output as desired.

The current output from the battery bank 126 may be provided to the inverter 133. The inverter 133 may be configured to convert a direct current received from the battery bank 126 into an alternating current that is to be provided to the powered structure 106 or to another destination. In various embodiments, the inverter 133 may provide a 120 volt/30 amp output, a 120 volt/60 amp output, a 120/240 volt/60 amp output, and/or other output levels. To this end, the inverter 133 may be a stand-alone inverter, a grid-tie inverter, a bimodal inverter, or any other suitable type of inverter.

The controller device 136 may be configured to monitor and/or control the operation of various components of the power supply unit 119. To this end, the controller device 136 may comprise one or more microcontrollers or other devices. Although FIG. 1 shows the controller device 136 in communication with the inverter 133 and the charge controllers 123a-123b, it is emphasized that fewer components or additional components may be in communication and under the monitoring and/or control of the controller device 136 in various embodiments. Additionally, various embodiments may include a communication hub or other device to distribute and/or manage communication between the controller device 136 and various components.

Next, a general description of the operation of the various components of the powered environment 100 is provided. To begin, it is assumed that the powered structure 106 is being powered by the grid power source 113. In addition, it is assumed that the auxiliary power source 109 is operational and ready for installation in accordance with the present disclosure.

The power supply unit 119 may be constructed and placed in the container 103. Further, the container may be placed in a location that is near, yet separate from, the powered structure 106. For example, the container 103 may be placed near a wall or other portion of the powered structure 106. Additionally, the container may be placed on a raised platform, for example, to prevent damage from flooding.

Upon the container 103 being placed near the powered structure 106, the power supply unit 119 may be electrically connected to the grid power source 113, the auxiliary power source 109, and possibly other sources. In addition, the output of the inverter 133 may be electrically connected to the powered structure 106.

After the container 103 and the power supply unit 119 contained therein have been installed, the battery bank 126 may begin the process of being charged from the grid power source 113, the auxiliary power source 109, and/or possibly other power sources. To this end, the controller device 136 may direct the charge controllers 123a-123b to control the charging currents that are provided to the battery bank 126.

The battery bank 126 may provide a current to the inverter 133 during the charging process and/or after the battery bank 126 has been charged to an amount predetermined by the controller device 136. Upon receiving the current from the battery bank 126, the inverter 133 may covert the current to an alternating current that is provided to the powered structure 106.

In various embodiments, the alternating current from the inverter 133 may be provided upon determining that the grid power source 113 has gone offline. By the battery bank 126 providing the current to the inverter 133, the stored energy in the batteries 129a-129d may begin to decrease. However, the charging current provided by the auxiliary power source 109 may at least partially recharge the batteries 129a-129d. Thus, the auxiliary power source 109 in conjunction with the battery bank 126 may provide a source of power for the powered structure despite the grid power source 113 being offline.

In various other embodiments, the alternating current from the inverter 133 may be provided even while the grid power source 113 is online. In this case, the current provided by the inverter 133 may be provided to and consumed by the powered structure 106. Additionally, if there is excess current from the inverter 133 that is not consumed by the powered structure 106, this current may be provided to the grid power source 113 through the powered structure 106.

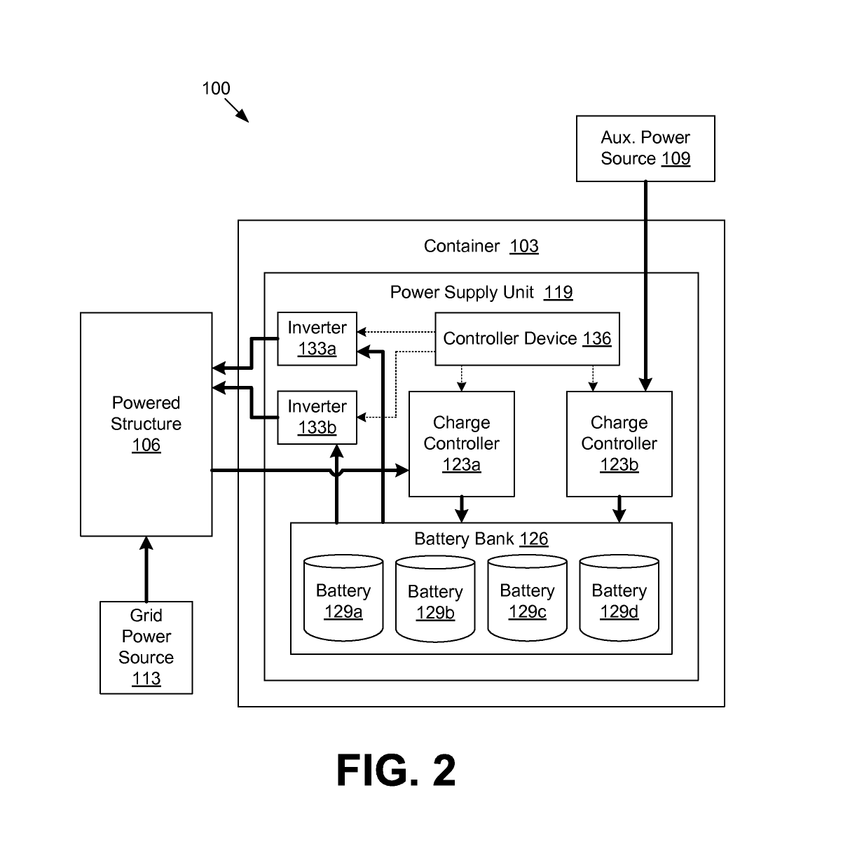

Referring next to FIG. 2, shown is an alternative embodiment, among many embodiments, of the present disclosure. The embodiment in FIG. 2 is similar to the embodiment shown in FIG. 1. However, in the embodiment of FIG. 2, the inverter 133 (FIG. 1) is replaced with multiple inverters 133a-133b.

In various embodiments, the multiple inverters 133a-133b may be arranged so as to provide the powered structure 106 with multiple voltage levels and/or multiple phases of power. By providing multiple voltage levels and/or multiple phases of power, the power supply unit 119 may facilitate powering large appliances or other devices, as may be appreciated.

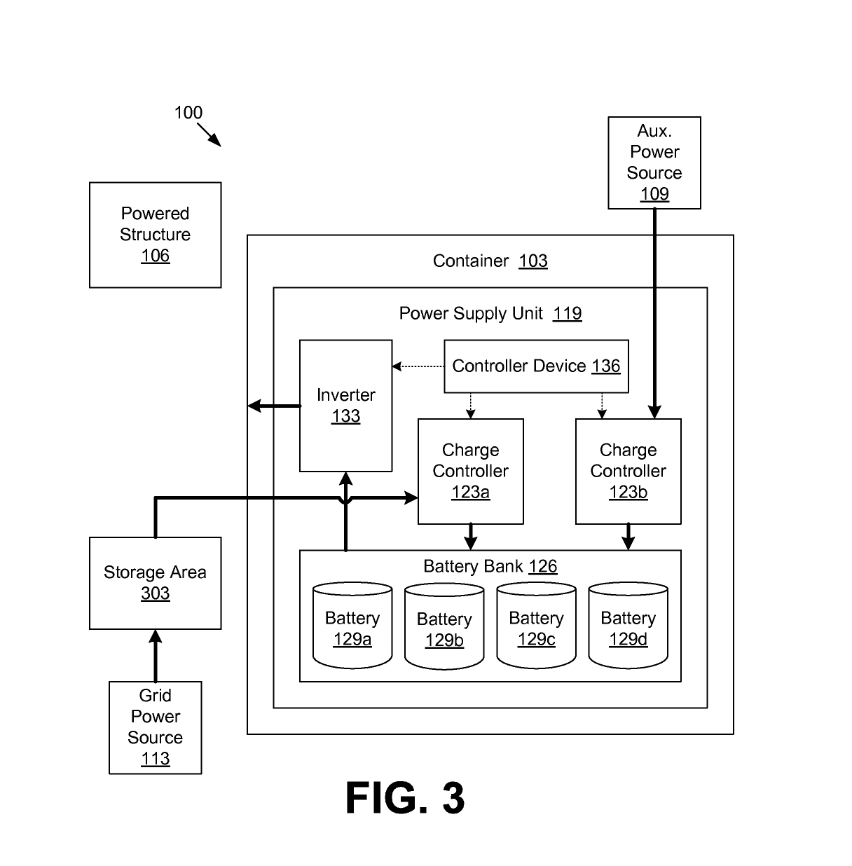

Turning now to FIG. 3, shown is an alternative embodiment, among many embodiments, of the present disclosure. The embodiment of FIG. 3 is similar to the embodiment shown in FIG. 1. However, in the embodiment of FIG. 3, the powered environment 100 further includes a storage area 303.

The storage area 303 may be, for example, a warehouse, garage, piece of land, or any other type of area for storing one or more of the containers 103. As may be appreciated, the grid power source 113 may be provided to the storage area 303.

Additionally, the grid power source 113 may be provided to the power supply unit 119. To this end, the power supply unit 119 may be electrically connected to the grid power source 113 through the storage area 303. Even further, in various embodiments the power supply unit 119 may be in electrical connection with the auxiliary power source 109 in order to obtain multiple charging currents.

In operation, one or more containers 103 and the power supply units 119 therein may be stored to await deployment. While at the storage area 303, the one or more power supply units 119 may be charged using the grid power source 113, the auxiliary power source 109, and/or other power sources.

In the event that the container 103 is to be deployed, the container 103 may be loaded onto a transportation unit (e.g., a truck or trailer). In alternative embodiments, the container 103 may already be mounted to the transportation unit. Thereafter, the container 103 may be transported to a location, such as a disaster relief staging area and/or at the powered structure 106.

Upon arriving at the powered structure 106, the power supply unit 119 may be electrically connected to the powered structure 106, as described above. Thereafter, the stored energy from the battery bank 126 may be used to provide power to the powered structure 106 from the battery bank 126, as described above. Additionally, the power supply unit 119 may be electrically connected to one or more auxiliary power sources 109 in order to charge the battery bank 126 and/or provide additional power to the powered structure 106.

Upon the powered structure 106 regaining grid power, the power supply unit 119 may be disconnected from the powered structure 106 and/or auxiliary power source 109 and returned to the storage area to recharge and await deployment.

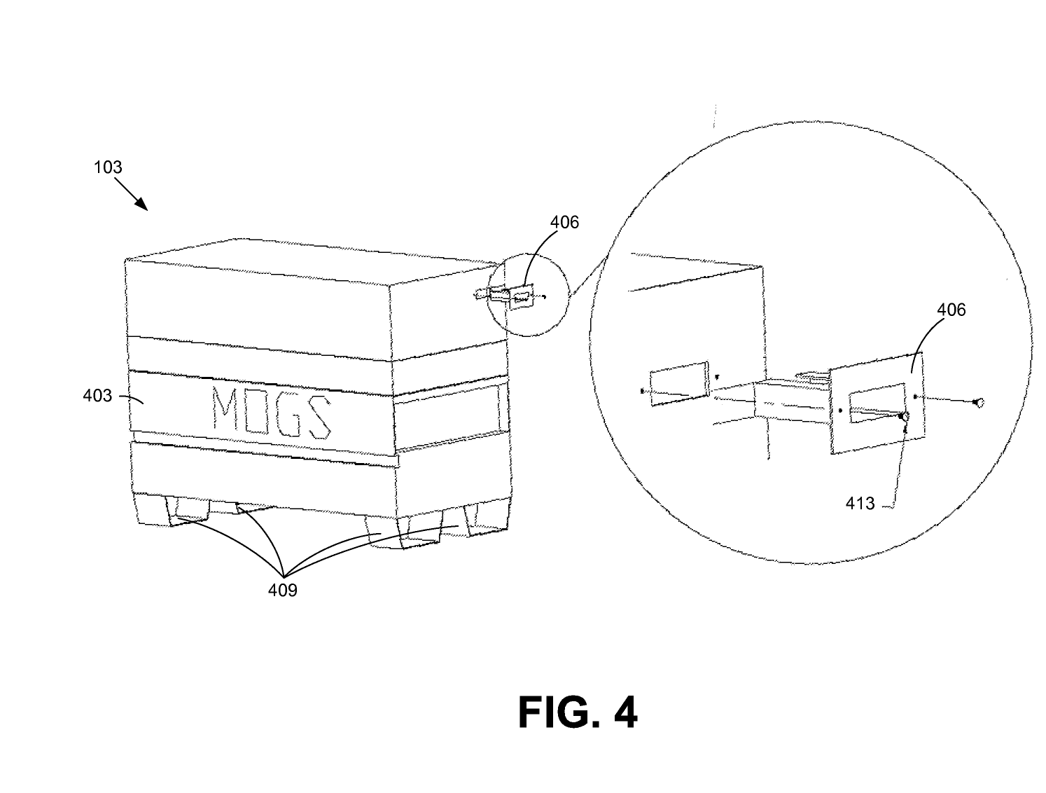

Moving on to FIG. 4, shown is a drawing showing an example of a container 103 in accordance with various embodiments. FIG. 4 depicts a modular feature of the present disclosure. As previously mentioned, the container 103 may enclose various components described herein. To this end, the container 103 may include a body 403, one or more ports 406, one or more stands 409, and possibly other features not discussed in detail herein.

The body 403 encloses and supports various components within the container 103. The stands 409 provide a platform for the body 403. Additionally, the stands 409 may elevate the body 403, thereby raising the body 403 and its components in the event of rising water, for example. Even further, the stands 409 may facilitate movement of the container 103 using a fork lift or other equipment. In this sense, the stands 409 may receive arms of the fork lift, for example.

The ports 406 may provide an electrical connection point between the powered structure 106, grid power source 113, auxiliary power source 109, and/or other components. To this end, one or more of the ports 406 may be embodied in the form of an Anderson SB plug or any other type of plug or socket. The ports 406 may extend through the body 403 and be attached to the body 403 using fasteners 413 or other attachment mechanisms.

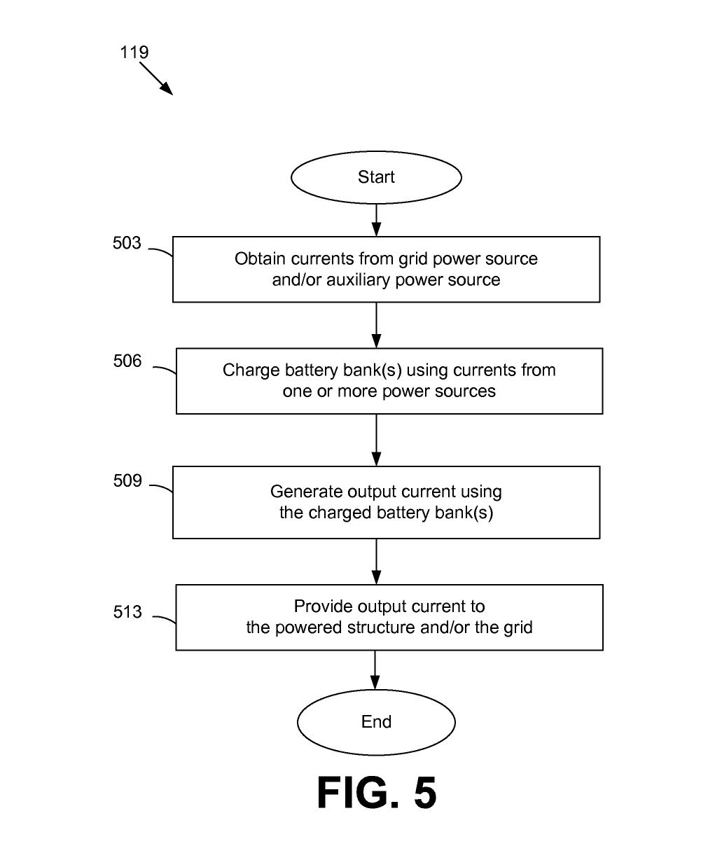

Referring next to FIG. 5, shown is a flowchart that provides one example of the operation of a portion of the power supply unit 119 according to various embodiments. It is understood that the flowchart of FIG. 5 provides merely an example of the many different types of functional arrangements that may be employed to implement the operation of the portion of the power supply unit 119 as described herein. As an alternative, the flowchart of FIG. 5 may be viewed as depicting an example of steps of a method implemented in the controller device 136 (FIG. 1) according to one or more embodiments.

Beginning with box 503, the power supply unit 119 obtains currents from the grid power source 113 (FIG. 1), the auxiliary power source 109 (FIG. 1), and/or possibly other sources. Next, as shown in box 506, the power supply unit 119 charges the one or more battery banks 126 using the currents from the grid power source 113, the auxiliary power source 109, and/or possibly other sources.

Moving to box 509, the power supply unit 119 then generates the output currents using the one or more charged battery banks 126. Thereafter, the output current is provided to the powered structure 106, as depicted in box 513. Thereafter, the process ends.

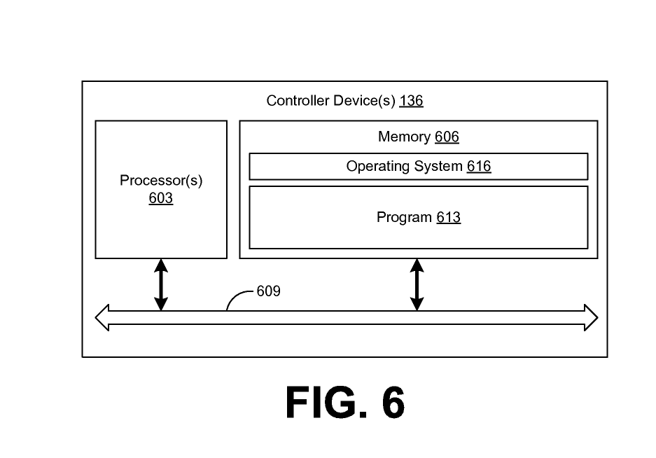

With reference to FIG. 6, shown is a schematic block diagram of the controller device 136 according to an embodiment of the present disclosure. The controller device 136 may include at least one processor circuit, for example, having a processor 603 and a memory 606, both of which are coupled to a local interface 609. To this end, the controller device 136 may comprise, for example, at least one microcontroller device or like device. The local interface 609 may comprise, for example, a data bus with an accompanying address/control bus or other bus structure as can be appreciated.

Stored in the memory 606 are both data and several components that are executable by the processor 603. In particular, stored in the memory 606 and executable by the processor 603 may be a program 613 and potentially other applications. Also stored in the memory 606 may be a data store (not shown) and other data. In addition, an operating system 616 may be stored in the memory 606 and executable by the processor 603.

It is understood that there may be other applications that are stored in the memory 606 and are executable by the processors 603 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction.

Although the program 613 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

Although the flowchart of FIG. 5 shows a specific order of execution, it is understood that the order of execution may differ from that which is depicted. For example, the order of execution of two or more blocks may be varied relative to the order shown. Also, two or more blocks shown in succession in FIG. 5 may be executed concurrently or with partial concurrence. Further, in some embodiments, one or more of the blocks shown in FIG. 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the program 613, that comprises software or code can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. An apparatus, comprising:
a container configured to be placed separate from a powered structure; and
a power supply unit housed by the container, the power supply unit comprising:
a battery bank configured to receive a plurality of charging currents corresponding to a plurality of power sources; and
an inverter electrically coupled to the battery bank, the inverter configured to generate an output current configured to be supplied to the powered structure.

2. The apparatus of claim 1, wherein the power supply unit further comprises at least one controller device in communication with the inverter.

3. The apparatus of claim 1, wherein the power supply unit further comprises a plurality of charge controllers configured to control the charging currents, each of the charge controllers configured to electrically couple to one of the power sources and to the battery bank.

4. The apparatus of claim 3, wherein the power supply unit further comprises at least one controller device in communication with the inverter and the charge controllers.

5. The apparatus of claim 1, wherein the inverter further comprises a plurality of inverters, and the output current configured to be provided to the powered structure comprises a plurality of phases.

6. The apparatus of claim 1, wherein at least one of the power sources is a grid power source from the powered structure.

7. The apparatus of claim 1, wherein at least one of the power sources is a grid power source located at a storage area.

8. The apparatus of claim 1, wherein at least one of the power sources is a grid power source, and at least one of the power sources an auxiliary power source.

9. A system, comprising:
a powered structure;
a container configured to be placed separate from the powered structure; and
a power supply unit housed by the container, the power supply unit comprising:
a battery bank configured to receive a plurality of charging currents corresponding to a plurality of power sources; and
an inverter electrically coupled to the battery bank, the inverter configured to generate an output current configured to be supplied to the powered structure.

10. The system of claim 9, wherein the power supply unit further comprises at least one controller device in communication with the inverter.

11. The system of claim 9, wherein the power supply unit further comprises a plurality of charge controllers configured to control the charging currents, each of the charge controllers configured to electrically couple to one of the power sources and to the battery bank.

12. The system of claim 11, wherein the power supply unit further comprises at least one controller device in communication with the inverter and the charge controllers.

13. The system of claim 9, wherein the inverter further comprises a plurality of inverters, and the output current configured to be provided to the powered structure comprises a plurality of phases.

14. The system of claim 9, wherein at least one of the power sources is a grid power source located at the powered structure.

15. The system of claim 9, further comprising a storage area, and at least one of the power sources is a grid power source located at a storage area.

16. The system of claim 9, wherein at least one of the power sources is a grid power source, and at least one of the power sources an auxiliary power source.

17. A method, comprising the steps of:
charging a battery bank using a plurality of power sources using a plurality of charge controllers;
generating an output current using an inverter that is electrically coupled to the battery bank; and
providing the output current from the inverter to a powered structure that is separate from a container comprising the battery bank, the charge controllers and the inverter.

18. The method of claim 17, further comprising the step of obtaining an input current from a grid power source.

19. The method of claim 17, further comprising the step of obtaining an input current from an auxiliary power source.

20. The method of claim 17, further comprising the step of adjusting the inverter or a charging parameter using at least one controller device.
